(19) United States
(12) Patent Application Publication
(10) Pub. No.: US 2026/0106524 A1
(43) Pub. Date: Apr. 16, 2026

(54) SYSTEMS AND METHODS FOR BOLTLESS BUSBAR JOINTS

(71) Applicant: Ford Global Technologies, LLC, Dearborn, MI (US)

(72) Inventors: John Casci, Pontiac, MI (US); Fan Wang, Novi, MI (US); Baoming Ge, Okemos, MI (US)

(21) Appl. No.: 18/917,417

(22) Filed: Oct. 16, 2024

(51) Int. Cl. H02K 15/00; B21D 22/02; B60L 15/00; H02K 3/50

(52) U.S. Cl. CPC H02K 15/32; B21D 22/02; B60L 15/007; H02K 3/50; H02K 2203/09

(57) ABSTRACT

Methods and systems are provided for assemblies including two busbars connected via boltless busbar joints, without fasteners. In one example, a method for connecting a first busbar to a second busbar without fasteners includes stamping the second busbar to form two slots separating a middle piece from prongs, bending the middle piece into a clip, and interposing the first busbar between the clip and the prongs. Additionally, contact areas of the first and second busbars are pre-treated with a surface texturing method.

### FIELD

The present description relates generally to joints between two busbars without bolts.

### BACKGROUND/SUMMARY

Two busbars may be joined (e.g., mechanically and electrically coupled) in electrical systems. For examples, a vehicle may comprise an inverter and an electric machine (e.g., a three phase electric machine) mechanically and electrically coupled via busbars. Many parts may be demanded for conventional assembly of the inverter and the electric machine with the busbars. For example, the parts of a conventional assembly may include busbars, a plurality of bolts and weld-nuts, a terminal block, a first housing for the inverter, a second housing for the electric machine, and a service cover that includes a seal, a plurality of bolts, and a high voltage interlocking loop system (HVIL). Such an assembly design is complex due to the number of parts, increasing resource demand, potential degradation modes, and manufacturing operations. Additionally, such a conventional assembly may demand space for the bolts and the busbars, thereby decreasing space efficiency of the assembly and reducing available space for other vehicle systems. Similar issues may arise in other systems than vehicles comprising busbar joints where bolts or other fasteners are conventionally used for assembly.

In one example, the issues described above may be addressed by a method for connecting a first busbar to a second busbar without fasteners, comprising: stamping the second busbar to form two slots separating a middle piece from prongs; bending the middle piece into a clip; and interposing the first busbar between the clip and the prongs, where contact areas of the first and second busbars are pre-treated with a surface texturing method. The clip and the prongs may compress the first busbar therebetween.

As one example, an assembly resulting from executing the method may include the first busbar and the second busbar removably, mechanically, and electrically coupled due to the first busbar being compressed between the prongs and the clip. The two busbars being connected without fasteners such as bolts may reduce parts demanded to secure the busbars together, thereby reducing materials and manufacturing operations. Further, the busbars may be separable due to the ability to release the compression and absence of permanent couplings such as soldered junctions. In this way, the busbars may be removable from one another to allow for repeated assembly and disassembly as demanded for maintenance. Further still, in the application of connecting an inverter with an electric machine described above, the boltless busbar joints of the present disclosure may in at least some examples remove demand for the service cover that may conventionally include a seal, fasteners, and an HVIL by removing the bolts previously used to couple the electric machine and the inverter. For example, contact areas at which the first busbar and the second busbar are in face-sharing contact when assembled may be pre-treated with a surface texturing method. The resulting surface textures may evenly distribute current, reduce hot spot formation, and increase security of the mechanical and electrical coupling between the first busbar and the second busbar. In this way, a likelihood of degradation may be reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an exemplary vehicle in which an assembly with a busbar joint of the present disclosure may be incorporated.

FIG. 2 shows a top view of an assembly with a boltless busbar joint in accordance with the present disclosure.

FIG. 3 shows a side view of the assembly.

FIG. 4 shows a schematic of a system including an electric machine, an ICS, and the assembly in accordance with the present disclosure.

FIG. 5 shows a schematic of an assembly including an electric machine, an ICS, and the assembly in accordance with the present disclosure.

FIG. 6 shows a textured surface of the assembly in accordance with the present disclosure.

FIG. 7 shows a method for creating an assembly comprising two busbars connected with a boltless busbar joint of the present disclosure.

FIG. 8 shows the busbars at different steps of the method of FIG. 7 in top views.

FIG. 9 shows the busbars at different steps of the method of FIG. 7 in side views.

### DETAILED DESCRIPTION

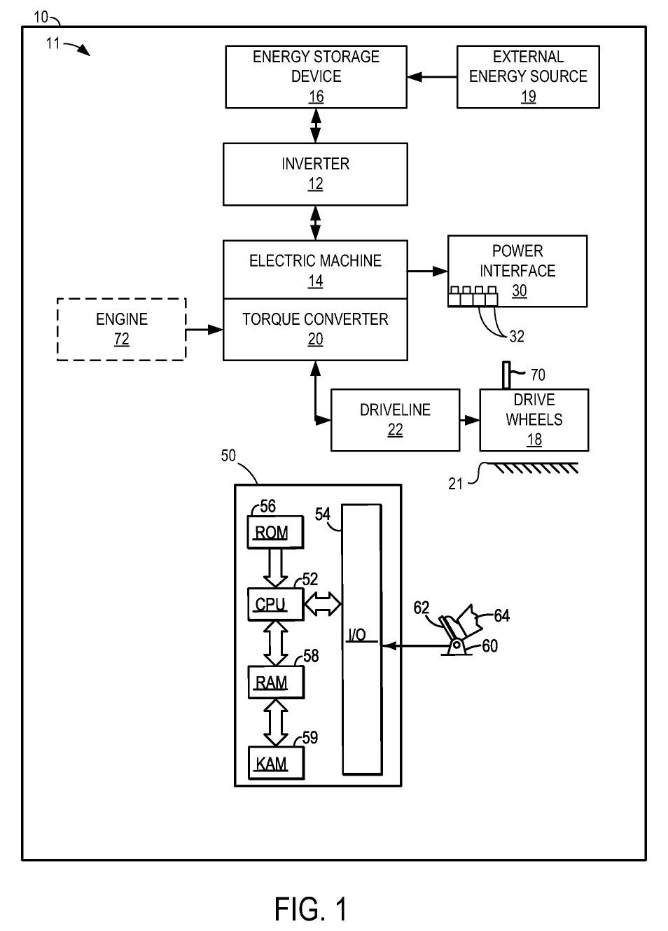

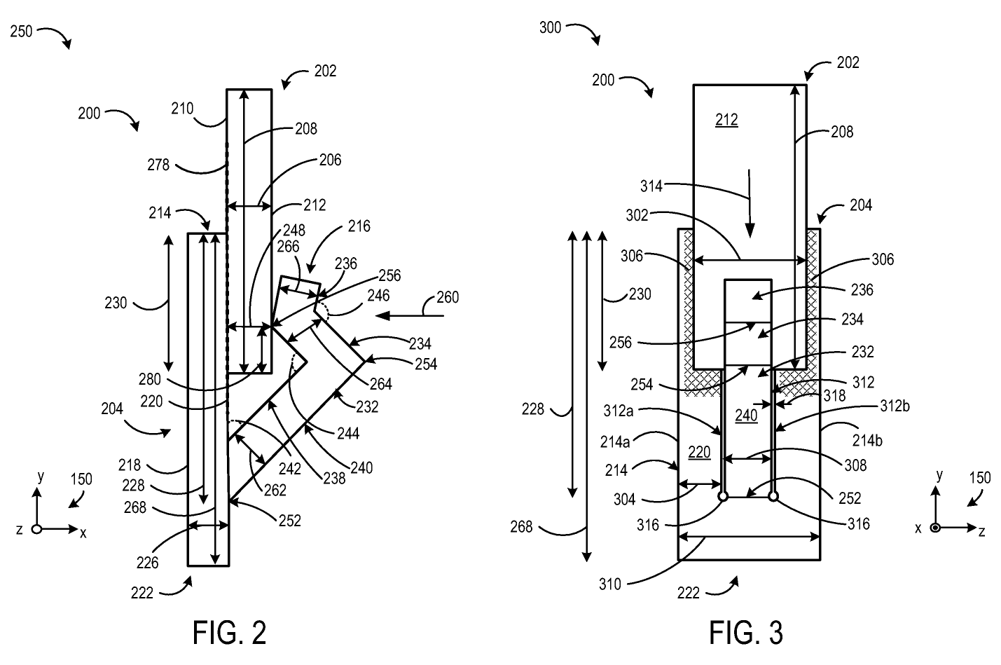

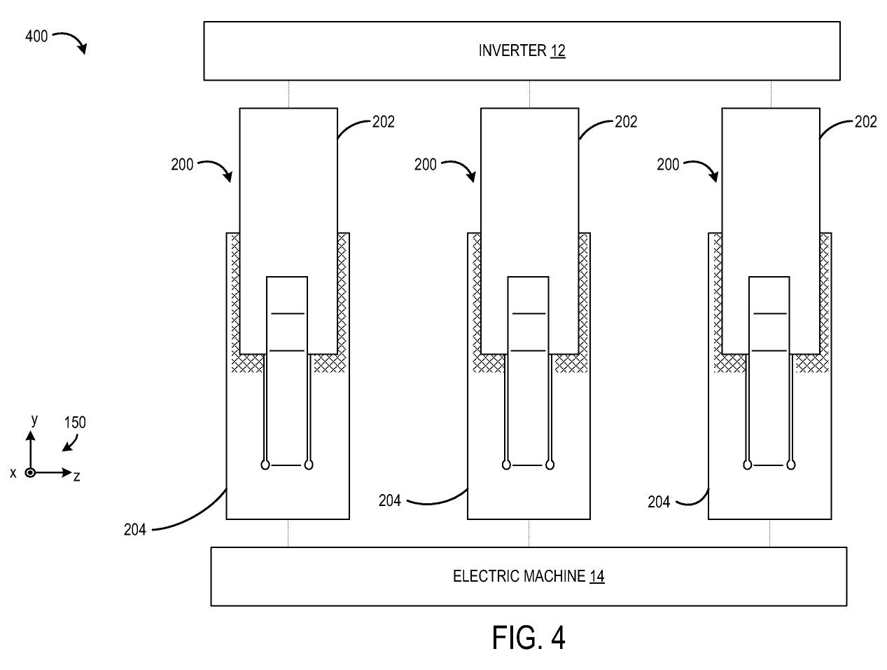

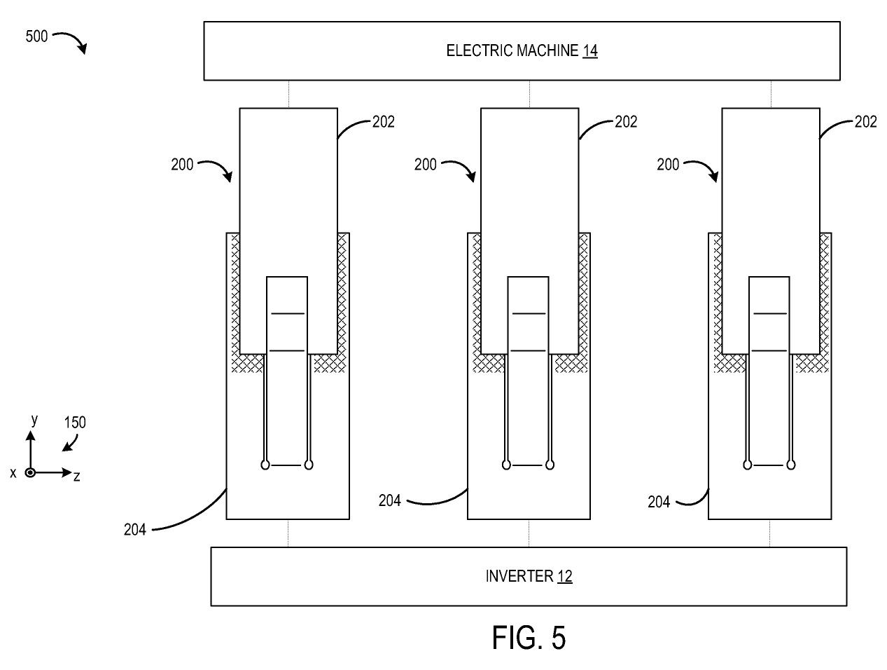

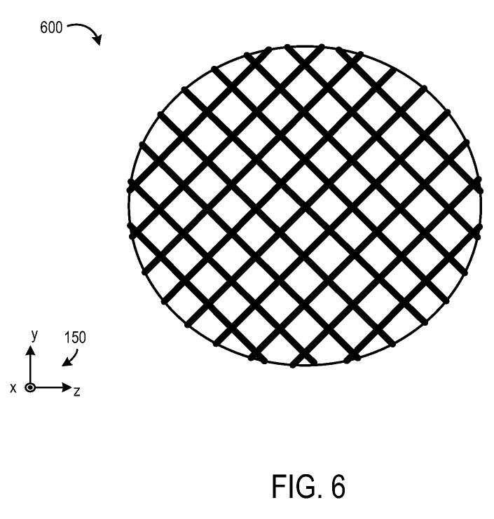

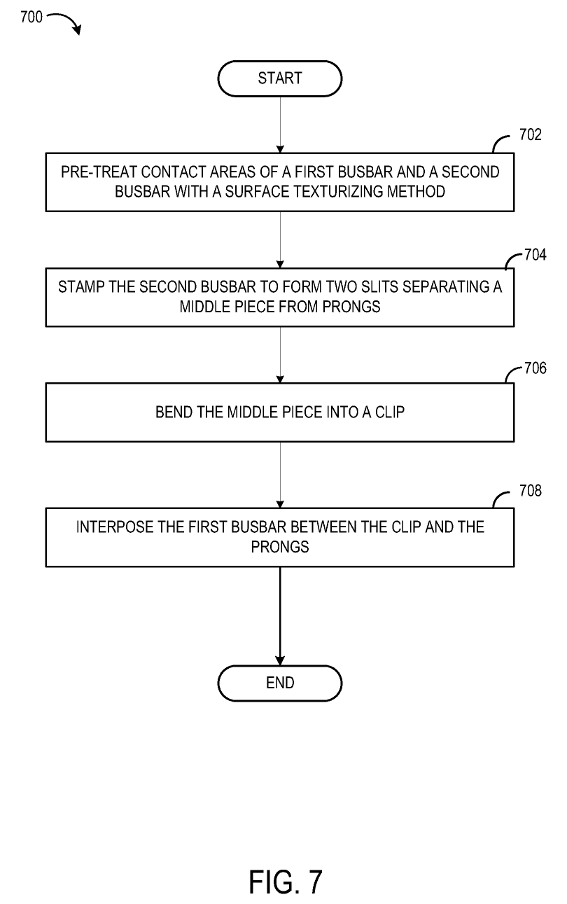

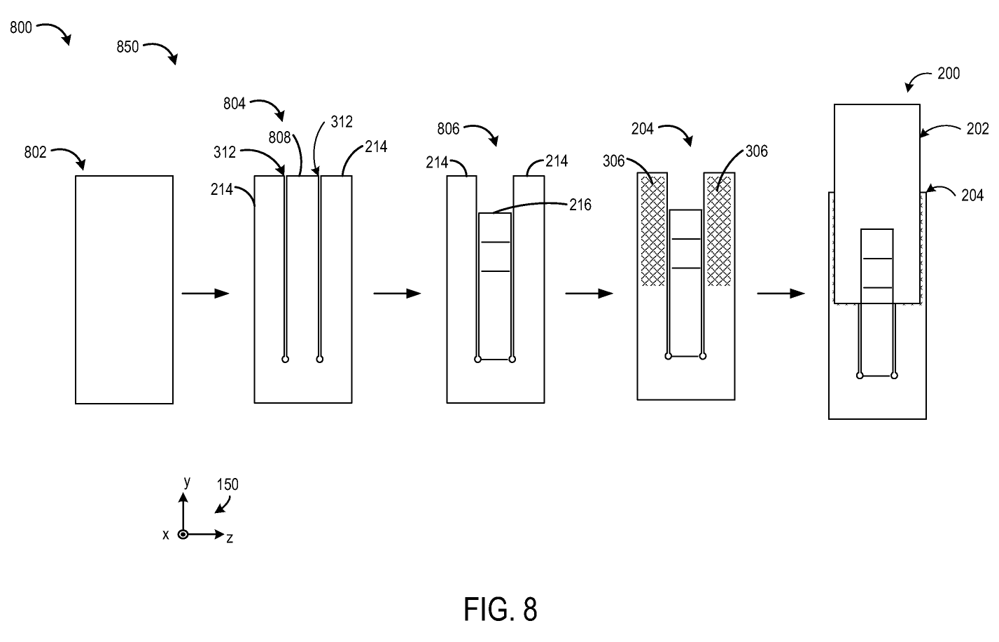

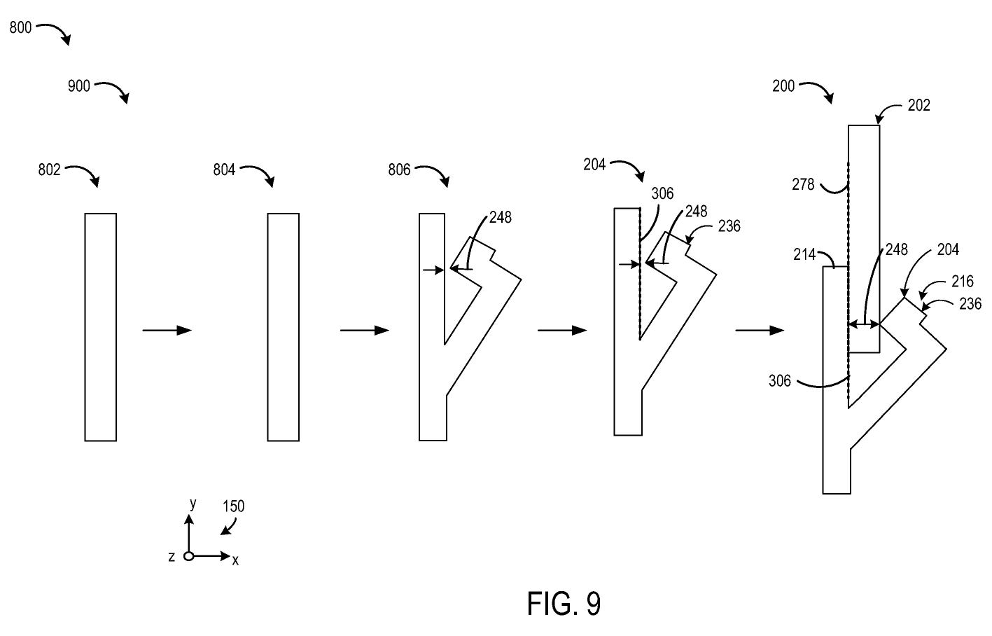

The following description relates to systems and methods for connecting two busbars via a boltless busbar joint, without bolts or other fasteners (e.g., screws, rivets, adhesive, solder, etc.). Various systems may demand mechanical and electrical coupling of busbars, such as vehicles comprising an electric machine and an inverter with busbars coupled therebetween. An example of such a vehicle is shown schematically in FIG. 1. An example of an assembly of two busbars electrically and mechanically coupled without fasteners is show in a top view and a side view in FIGS. 2 and 3, respectively. As shown in examples in FIGS. 4 and 5, the assembly may be incorporated in various configurations between two components, such as the electric machine and the inverter, to electrically and mechanically couple the components. The two busbars may be joined via compression and friction, rather than fasteners. In this way, an assembly of two busbars may be formed without any other parts for fastening, with the two busbars securely and removably coupled. To form such a connection between the two busbars without fasteners, one of the busbars may be stamped and bent to form a clip and prongs. The other busbar may be interposed and compressed between the clip and the prongs. Additionally, contact areas at which the two busbars are in face-sharing contact may be pre-treated with a surface texturing method to increase friction. For example, the surface texturing method may produce a surface texture with a cross-hatched pattern such as shown in FIG. 6. A method for coupling two busbars without fasteners in accordance with the present disclosure is provided in FIG. 7. The process that is shown as a flowchart in FIG. 7 is shown visually in top views and side views of the busbars in FIGS. 8 and 9, respectively.

By joining the busbars via a boltless joint where the clip and the prongs compressively hold the first busbar, parts demanded in the assembly for electric and mechanical coupling are decreased, thereby decreasing resource demand, complexity of manufacturing and assembling, and spatial demands of the system. For example, not including bolts may reduce materials and other resources, as well as space occupied by such materials. Further, manufacturing steps may be decreased by not demanding formation of bolts, nuts, and holes receiving the bolts. In this way, the boltless busbar joints of the present disclosure may be a simpler design for coupling busbars compared to conventional systems including fasteners such as bolts. Additionally, the surface textures formed on contact areas of the busbars may increase security (e.g., resistance to separation) of the joint. Moreover, the surface textures may reduce hot spots by evening out current flux over the contact areas between the busbars, protecting the surface finish from degradation. Further still, a service cover including a seal and high voltage interlocking loop system (HVIL) may not be demanded for systems including the boltless busbar joints of the present disclosure, further decreasing parts and correspondingly decreasing resource demand and manufacturing operations.

Turning now to FIG. 1, an example of a vehicle 10 with a propulsion system 11 (e.g., electric propulsion system) is shown. Propulsion system 11 includes an electric machine 14 (e.g., energy conversion device). Electric machine 14 is controlled via controller 50. Electric machine 14 is coupled to an inverter 12 configured to condition electrical energy in and out of an energy storage device 16. The electric machine 14 may be coupled to the inverter 12 via one or more boltless busbar joints in accordance with the present disclosure (e.g., assembly 200 of FIGS. 2-5). In some examples, vehicle propulsion system 11 may further include an engine 72, where engine 72 may be an internal combustion engine.

Electric machine 14 can be operated to convert mechanical energy received from a driveline 22 into an energy form suitable for storage by the energy storage device (e.g., provide a generator operation). Electric machine 14 can also be operated to supply an output (power, work, torque, speed, etc.,) to drive wheels 18 (e.g., provide a motor operation). It should be appreciated that electric machine 14 may, in some embodiments, function only as a motor, only as a generator, or both a motor and generator, among various other components used for providing the appropriate conversion of energy between the energy storage device and drive wheels 18. For instance, electric machine 14 may include a motor, a generator, integrated starter generator, starter alternator, among others and combinations thereof.

Energy storage device 16 may include a battery, a capacitor, inductor, or other electric energy storage device. Energy storage device 16 may be selectively coupled to an external energy source 19. For example, energy storage device 16 device may be periodically coupled to a charging station (e.g., commercial or residential charging station), portable energy storage device, etc., to allow energy storage device 16 to be recharged.

Electric machine 14 is coupled to a torque converter 20. Torque converter 20 is a fluid coupling designed to transfer rotational input from electric machine 14 to driveline 22. Driveline 22 includes a transmission with gearing and other suitable mechanical components (e.g., a gearbox, axles, transfer cases, etc.) designed to transfer rotational motion to drive wheels 18. Drive wheels 18 may be supported by and drive vehicle 10 across a surface 21. Torque converter 20 and electric machine 14 are depicted as an interconnected unit. However, in other examples, torque converter 20 and electric machine 14 may include discrete enclosures.

Electric machine 14 may include one or more clutches designed to selectively rotationally couple the machine’s rotor to torque converter 20. For instance, the clutch or clutches may each include plates, splines, and/or other suitable mechanical components allowing the machine to be rotationally connected as well as disconnected from the engine or the torque converter.

The depicted connections between electric machine 14, driveline 22, and drive wheel 18 indicate transmission of mechanical energy from one component to another, whereas the connections between electric machine 14 and energy storage device 16 may indicate transmission of a variety of energy forms such as electrical, mechanical, etc. For example, torque may be transmitted from electric machine 14 to vehicle drive wheels 18 via driveline 22. As described above, electric machine 14 may be configured to operate in a generator mode and/or a motor mode. In a generator mode, propulsion system 11 receives some or all of the output from electric machine 14, which reduces the amount of drive output delivered to drive wheels 18, or the amount of wheel caliper torque to drive wheels 18. Such operation may be employed, for example, to achieve energy efficiency gains through energy recovery, increased engine efficiency (if included), etc. Further, the output received by electric machine 14 may be used to charge an energy storage device 16 via the inverter 12. In motor mode, electric machine 14 may supply mechanical output to driveline 22, for example by using electrical energy stored in energy storage device (e.g., an electric battery) and provided to the electric machine 14 via the inverter 12. Additionally, an engine may supply rotational output to driveline 22, in some instances.

Electric machine 14 may also be used to deliver electrical energy to external, auxiliary devices during power take-off. Electric machine 14 may run during power take-off but drive wheels 18 are not in motion, allowing power output from electric machine 14 to be directed at least partially towards operating the auxiliary devices. Vehicle 10 may include a power interface 30 arranged along an electrical circuit of vehicle 10. The power interface may have a plurality of power outlets 32, each outlet electrically coupled to electric machine 14, and plugging the auxiliary devices into the plurality of outlets allows power to be supplied to the auxiliary devices. The arrow extending between electric machine 14 and power interface 30 indicates the transfer of electrical energy therebetween.

In examples where vehicle 10 comprises engine 72, engine 72 may have an output coupled to torque converter 20 and may be incorporated into the axle of the vehicle. Engine 72 may be controlled via controller 50. Both engine 72 and electric machine 14 may act as movers to drive the vehicle 10. For example, vehicle 10 may be a hybrid vehicle. In examples including engine 72, rotational energy in the form of torque from engine 72 or other rotational and mechanical energy from components may be converted into electrical energy by electric machine 14. The output of electric machine 14 to torque converter 20 may act as input for the transfer and transformation of torque into electrical energy during hybrid operations.

Controller 50 receives signals from various sensors and employs various actuators to adjust vehicle operation based on the received signals and instructions stored in non-transitory memory of the controller 50. Specifically, controller 50 is shown in FIG. 1 as a conventional microcomputer including: microprocessor unit 52, input/output ports 54, read-only memory 56, random access memory 58, keep alive memory 59, and a data bus. Controller 50 is configured to receive various signals from sensors coupled to propulsion system 11 and send command signals to actuators in components in vehicle 10, such as the electric machine 14. Additionally, the controller 50 is also configured to receive pedal position from a pedal position sensor 60 coupled to a pedal 62 actuated by a user 64. Therefore, in one example, controller 50 may receive a pedal position signal and adjust actuators in electric machine 14 based the pedal position signal to vary the rotational output of electric machine 14. The sensors communicating with controller 50 may include an electric machine sensor (e.g., resolver or Hall effect sensor for sensing a rotor position of the electric machine), and wheel speed sensor 70, accelerometer, etc. Controller 50 may adjust an output voltage of the inverter 12, or other aspects of current transferred between the inverter 12 and the electric machine 14.

The inverter 12 and the electric machine 14 may be mechanically and electrically coupled via busbars. Conventionally, bolts may be used for such mechanical and electrical coupling. However, such conventional methods may demand a service cover that includes a seal, a plurality of bolts, and a high voltage interlocking loop system (HVIL) to reduce likelihood of degradation to the mechanical and electrical coupling. Boltless busbar joints in accordance with the present disclosure may be used to mechanically and electrically couple the inverter 12 and the electric machine 14, as further described below, without demanding such a service cover and without fasteners for forming the mechanical and electrical coupling between the busbars. Reduced parts and less complex fabrication may reduce resource demand and increase ease of disassembly and reassembly as desired (e.g., for servicing of the electric machine 14 or the inverter 12).

Turning to FIGS. 2 and 3, a busbar assembly 200 is shown in a side view 250 and a top view 300, respectively. A set of reference axes 150, including an x-axis, a y-axis, and a z-axis, are shown in FIGS. 2-6, 8, and FIG. 9. In the reference axes 150, a filled dot may indicate the labeled axis is directed positively into the page and an unfilled dot may indicate the labeled axis is directed positively out of the page. The y-axis may be a lengthwise axis of the assembly 200, the z-axis may be a widthwise axis of the assembly 200, and the x-axis may be a depthwise axis of the assembly 200. However, other orientations of the reference axes 150 are possible.

The busbar assembly 200 includes a first busbar 202 and a second busbar 204, where the first busbar 202 and the second busbar 204 are coupled without bolts. Due to having a boltless busbar joint between the first busbar 202 and the second busbar 204, the busbar assembly 200 may be a boltless busbar assembly. Further, the first busbar 202 and the second busbar 204 may be electrically and mechanically coupled to one another without utilization of any other components.

The first busbar 202 may be shaped as a conventional busbar. For example, the first busbar 202 may be rectangular prism shaped with a thickness 206 parallel with the x-axis, a length 208 parallel with the y-axis, and a width 302 parallel with the z-axis. The thickness 206 may be smaller than the length 208 and the width 302. For example, the first busbar may be flat. The length 208 may be larger than the width 302 and the thickness 206. The first busbar 202 may include a prong contact surface 210 and a clip contact surface 212. The prong contact surface 210 and the clip contact surface 212 may be in parallel planes facing opposite directions (e.g., positive and negative x-directions).

The second busbar 204 may comprise prongs 214, including a first prong 214a and a second prong 214b, and a clip 216. The prongs 214 may be positioned on either side of the clip 216. For example, in the top view 300, the first prong 214a is to the left of the clip 216 ad the second prong 214b is to the right of the clip 216. The prongs 214 and the clip 216 may extend in the positive y-direction from a base 222. The base 222, the prongs 214, and the clip 216 may be integrally formed as a single continuous piece. Thus, the second busbar 204 may be constructed from a conventionally shaped busbar (e.g., substantially the same as the first busbar 202) by stamping (e.g., laser cutting, water cutting, electrical discharge machining (EDM), punching, etc.) and bending to separate the prongs 214 and the clip 216, as described further below in regards to FIGS. 7-9. The prong contact surface 210 may be configured in face-sharing contact with the prongs 214 over the contact area length 230. The clip contact surface 212 may be configured in face-sharing contact with the clip 216 a non-zero distance 280 from the end of the first busbar 202. In this way, the first busbar 202 may be in face-sharing contact with both of the two prongs 214 and the clip 216.

The prongs 214 may include a thickness 226 parallel with the x-axis, a length 228 parallel with the y-axis, and a width 304 parallel with the z-axis. Each of the first prong 214a and the second prong 214b may include a prong outer surface 218 and a prong inner surface 220. The prongs 214 may be side by side such that the prong outer surfaces 218 are coplanar and the prong inner surfaces 220 are coplanar. The prong inner surfaces 220 may face the clip 216. The prong outer surfaces 218 may face away from the clip 216. The prong inner surfaces 220 may face directly opposite from the prong outer surfaces 218. The prong inner surfaces 220, the prong outer surfaces 218, the prong contact surface 210, and the clip contact surface 212 may be parallel flat surfaces. The prong inner surfaces 220 and the clip contact surface 212 may face a first direction, while the prong outer surfaces 218 and the prong contact surface 210 may face a second direction opposite the first direction. When the first busbar 202 and the second busbar 204 are joined via the boltless busbar joint, the prong inner surfaces 220 may be in face-sharing contact with the prong contact surface 210 along a contact area length 230. The contact area length 230 may be less than the length 208 and the length 228 such that portions (e.g., less than the whole) of the prong inner surfaces 220 and the prong contact surface 210 may be in face-sharing contact.

The clip 216 may include bends, forming segments including a first segment 232, a second segment 234, and a third segment 236. The first segment 232 may extend between the base 222 and the second segment 234, the second segment 234 may extend between the first segment 232 and the third segment 236, and the third segment may extend from the second segment 234 to an end of the clip. The bends may include a first bend 252 between the prongs 214 and the first segment 232, a second bend 254 between the first segment 232 and the second segment 234, and a third bend 256 between the second segment 234 and the third segment 236. The first segment 232 may be bent at a first angle 242 with the prongs 214. The second segment 234 may be bent at a second angle 244 with the first segment 232. The third segment 236 may be bent at a third angle 246 with the second segment 234. The third segment 236 may be a tab by which the clip 216 may be manually pulled away from the prongs 214, increasing the first angle 242 and/or the second angle 244. The first angle 242, the second angle 244, and the third angle 246 may be non-zero angles. The first angle 242, the second angle 244, and the third angle 246 may be different than shown in the figures.

The first segment 232 and the third segment 236 may be bent in opposite directions from the second segment 234 such that the clip 216 is S-shaped, rather than U-shaped. For example, the first segment 232 may extend downwards (e.g., in the negative y-direction) and to the left (e.g., in the negative x-direction) from the second segment 234. In such an example, the third segment 236 may extend upwards (e.g., in the positive y-direction) and to the right (e.g., in the positive x-direction) from the second segment 234. In this way, the first segment 232 and the third segment 236 may have a positive x-y slope while the second segment 234 may have a negative x-y slope. In some examples, the third segment 236 may be parallel with the first segment 232 such that the thickness 262 is parallel to the thickness 266, and the third segment 236 and the first segment 232 are bent in directly opposite directions. In other examples, the first segment 232 and the third segment 236 may not be parallel such that the first segment 232 and the third segment 236 are bent in nearly opposite directions. In at least some examples, none of the first segment 232, the second segment 234, or the third segment 236 may be parallel with one another.

In other examples, the third segment may 236 not be included such that the clip 216 is L-shaped and ends at the second segment 234. In yet other examples, there may be more than three bends such that the clip 216 comprises more than three segments. For example, there may be an additional segment positioned flush with the first busbar 202 such that contact area is increased for further friction.

The first segment 232 may have a first segment thickness 262. The second segment 234 may have a second segment thickness 264. The third segment 236 may have a third segment thickness 266. The first segment thickness 262, the second segment thickness 264, and the third segment thickness 266 may be approximately equal in at least some examples. Further, the first segment thickness 262, the second segment thickness 264, and the third segment thickness 266 may be approximately equal to the thickness 226 of the prongs 214 and the base 222. In this way, the second busbar 204 may be formed from a conventionally shaped blank busbar with even thickness by stamping (e.g., laser cutting, water cutting, EDM, punching, etc.) and bending the blank busbar, as described with regards to FIGS. 7-9.

The clip 216 may include clip inner surfaces 238 and clip outer surfaces 240, the clip inner surfaces 238 and the clip outer surfaces 240 both extending along opposite sides of the first segment 232, the second segment 234, and the third segment 236. The clip inner surfaces 238 may not be coplanar or parallel with each other due to the second angle 244 and the third angle 246. Likewise, the clip outer surfaces 240 may not be coplanar or parallel with each other due to the second angle 244 and the third angle 246. Further, the clip inner surfaces 238 and the clip outer surfaces 240 may not be parallel with the prong inner surfaces 220 or the prong outer surfaces 218. The clip inner surfaces 238 may face towards the prongs 214 and the clip outer surfaces 240 may face away from the prongs 214. For example, the clip inner surfaces 238 may be located closer to the prongs 214 than the clip outer surfaces 240. Similarly, the prong inner surfaces 220 may be positioned closer to the clip 216 than the prong outer surfaces 218. In this way, the prong inner surfaces 220 and the clip inner surfaces 238 may face towards each other while the prong outer surfaces 218 and the clip outer surfaces 240 may face away from each other.

The clip 216, including the first segment 232, the second segment 234, and the third segment 236, may have a clip width 308. In some examples, the clip width 308 may be approximately the same as the prong width 304. In other examples, the clip width 308 may be greater than or less than the prong width 304. The clip width 308 may be smaller than the width 302 such that the first busbar 202 spans laterally across the clip 216 and at least partially across both of the prongs 214.

Slots 312 may separate the prongs 214 from the clip 216 in the z-direction, as shown in the top view 300. A first slot 312a may be between the clip 216 and the first prong 214a, and a second slot 312b may be between the clip 216 and the second prong 214b. The slots 312 may each have a slot width 318. A sum of the slot widths 318, the clip width 308, and the prong widths 304 may be approximately equal to busbar width 310 of the second busbar 204. The slots 312 may extend partially along length 268 of the second busbar 204, at least as far as the contact area length 230. The slots 312 may be perpendicular with the first bend 252, the second bend 254, and the third bend 256. The slots 312 may end at the first bend 252 with circular portions 316. The circular shape of the circular portions 316 of the slots 312 may increase flexibility of the first bend 252 to allow for insertion of the first busbar 202 into the space between the clip 216 and the prongs 214 in the direction indicated by the arrow 314, as described further below. Additionally, the circular portions 316 may relieve stress on the first busbar 202 due to bending the clip 216.

As described above, the first busbar 202 and the second busbar 204 may be reversibly joined mechanically and electrically. For example, the first busbar 202 and the second busbar 204 may be mechanically and electrically connected into the assembly 200 without inclusion of other components, such as bolts. The first busbar 202 and the second busbar 204 may be separable so as to disassemble the assembly 200 (e.g., to decouple an electric machine and an inverter) as demanded. By reducing components, complexity and spatial demands may be reduced.

The first busbar 202 and the second busbar 204 may be secured by normal force between the clip 216 and the prongs 214 clamping the first busbar 202 therebetween. For example, the second busbar 204 is shown in an elastically deformed position in which the second busbar 204 presses against the first busbar 202. A resting position of the second busbar 204 may include the first angle 242 and/or the second angle 244 being narrower than shown in FIG. 2 such that a lateral distance 248 (e.g., parallel with the x-axis) of an opening between the clip 216 (e.g., the third bend 256) and the prong inner surfaces 220 is smaller than the thickness 206 of the first busbar 202. When securing the first busbar 202 and the second busbar 204, the second busbar 204 may be elastically deformed from the resting position to receive the first busbar 202 between the prongs 214 and the clip 216. When tension is released to clamp the first busbar between the prongs 214 and the clip 216, the busbars 202, 204 are removably, mechanically, and electrically coupled. The second busbar 204 may be elastically deformed in the assembly 200 such that the first angle and/or the second angle are greater compared to a resting position of the second busbar 204. For example, the clip 216 may be under elastic tension. In this way, tendency of the first angle 242 and/or the second angle 244 to re-narrow applies compressive forces to the first busbar from both sides (e.g., prong contact surface 210 and clip contact surface 212), clamping the first busbar 202 between the prongs 214 and the clip 216. When subsequently separating the first busbar 202 and the second busbar 204, the second busbar 204 may return to the resting position. Thus, the second busbar 204 may be constructed of a material capable of elastic deformation, resulting in inward compressive elastic tension when the prongs 214 and the clip 216 are pulled in outwards directions (e.g., away from each other). In this way, the first busbar 202 and the second busbar 204 may be separable by releasing the elastic tension (e.g., removing the first busbar 202 from between the prongs 214 and the clip 216).

During insertion of the first busbar 202 into a space between the clip 216 and the prongs 214, opening the clip 216 may widen the space. For example, an installer may pull the third segment 236 away from the prongs 214, increasing the first angle 242 and/or the second angle 244 to increase the distance 248 between the prongs 214 and the point on the clip 216 which contacts the first busbar 202. In this way, the busbars 202, 204 may be aligned with parallel lengths 208, 228 during joining of the busbars 202, 204. The installer may release the tension pulling the third segment 236 away from the prongs 214, allowing the clip 216 to press against the clip contact surface 212. Due to the tendency of the second busbar 204 to return to the resting position with the distance 248 less than the thickness 206, the clip 216 may apply a force in a direction indicated by arrow 260 to mechanically secure the first busbar 202 to the second busbar 204 with the first busbar inserted between the prongs 214 and the clip 216. As the busbars 202, 204 are pressed together, the compressive forces between the clip 216 and the prong inner surfaces 220 may join the busbars 202, 204 firmly over the contact area length 230.

Further, contact areas on each of the first busbar 202 and the second busbar 204 may be pre-treated with a surface texturing method. Contact areas may be surfaces where the first busbar 202 is in face sharing contact with the prongs 214 and the clip 216 (e.g., the prong contact surface 210 and the prong inner surfaces 220). For example, portions or the entirety of the prong inner surfaces 220 may be pre-treated with the surface texturing method to produce textured surfaces 306. Additionally, portions or the entirety of the prong contact surface 210 may be pre-treated with the surface texturing method to produce textured surfaces 278. In some examples, some of the surfaces of the busbars may be textured (e.g., prong inner surfaces 220 and prong contact surface 210) and others may remain relatively smooth. For example, surfaces configured in face-sharing contact with the other busbar may be textured. In other examples, all surfaces of the busbars 202, 204 may have even texture. In such examples, all surfaces may be textured with the surface texturing method to increase roughness compared to conventionally smooth busbars. The textured surfaces such as first textured surfaces 306 and the second textured surfaces 278 (e.g., micro-textured surfaces) may strengthen the mechanical and electrical connection of the boltless joint between the first busbar 202 and the second busbar 204 by increasing surface areas (e.g., on the micro-scale). Increasing mechanical connection may prevent physical separation of the busbars 202, 204 during operation of a system including the assembly 200 such as the vehicle 10 of FIG. 1. Increasing electric connection may facilitate even current travel and reduce (e.g., avoid) hotspots that might deform the contact areas over time. Examples of the surface texturing method may include controlled abrasive polishing, electromechanical polishing with masking, laser surface texturing, micro-blasting, or a combination thereof. The surface texture patterns formed by such methods (or other surface texturing methods not listed) may be designed and oriented to allow for vertical slip to reduce (e.g., prevent) degradation of the surface texture patterns during operations (e.g., installation, servicing, etc.) where the first busbar 202 and the second busbar 204 are joined and/or separated by vertically sliding relative to one another.

An example of a surface texture pattern 600 formed into surfaces of the busbars 202, 204 is shown in FIG. 6. The surface texture pattern 600 may be a cross-hatch pattern with lines that are not parallel with lengths or widths of the first busbar 202 and the second busbar 204 of FIGS. 2-5 (e.g., not parallel to the y-axis or the z-axis). In other examples, the surface texture pattern may include bumps, divots, parallel lines, orthogonal lines, skew lines, lock fitting grooves, a combination thereof, etc. In some examples, the contact surfaces of both the busbars 202, 204 may have substantially the same surface texture pattern. In other examples, the contact surfaces may have two or more different surface texture patterns. For example, the different surface texture patterns may be complementary to one another.

In this way, the surface texture pattern 600 may allow slip during movement of the busbars (e.g., the first busbar 202 and the second busbar 204) relative to each other in the y-direction, increasing friction between the busbars without inducing degradation to the surface texture pattern 600 as described above. For example, referring to FIGS. 2-3, the surface texture pattern may allow for slip in the direction shown by arrow 314 that is parallel with the prongs 214, the slots 312, and the lengths 208, 228, 268. The surface texture pattern 600 may be polished into the contact surface areas on the busbars (e.g., prong inner surfaces 220 and prong contact surface 210) to increase surface area and friction force, increasing stability of the mechanical connection between the busbars. In this way, the boltless busbar joint between the busbars may withstand dynamic (e.g., driving) conditions without separating due to motion.

Turning to FIG. 4, a first example of the assembly 200 configured between the inverter 12 and the electric machine 14 is shown in a view 400. The number and orientation of assemblies 200 included may be selected based upon the configurations of the inverter 12 and the electric machine 14. For example, the inverter 12 is shown as a three-phase inverter, demanding three assemblies 200.

In the view 400, the first busbars 202 are electrically coupled to the inverter 12, and the second busbars 204 are electrically coupled to the electric machine 14, as indicated by the dashed lines. For example, the first busbars 202 may be welded to an alternating current (AC) terminal of the inverter 12. In such an example, the first busbars 202 may be part of the inverter 12. Additionally or alternatively, the second busbars 204 may be welded to motor winding terminals of the electric machine 14. As another example, there may be intermediate busbars interposed between the motor winding terminals and the second busbars 204. That is, the electric machine 14 may be electrically coupled to the second busbars 204 via the intermediate busbars, rather than directly. In such an example, the intermediate busbars may be mounted to a sealed block, where the sealed block is secured (e.g., bolted) to or integral with a housing of either the inverter 12 or the electric machine 14, separate from the assemblies 200. The sealed block may separate fluid (e.g., lubricant, coolant, etc.) within the electric machine 14 from entering the inverter 12. In this way, the assemblies 200 may electrically and mechanically couple the inverter 12 and the electric machine 14 without bolts, nuts, and the like. Further, the assemblies 200 may reversibly couple and decouple (e.g., mechanically and electrically separate) the inverter 12 and the electric machine 14. For example, no other components than the first busbar 202 and the second busbar 204 may be demanded to couple and decouple the inverter 12 and the electric machine 14.

Other configurations of the assemblies 200 in electrical systems are possible. Another example of the assembly 200 configured between the inverter 12 and the electric machine 14 is shown in a view 500 in FIG. 5. In the view 500, the first busbars 202 are electrically coupled to the electric machine 14, and the second busbars 204 are electrically coupled to the inverter 12. For example, the second busbars 204 may be welded to the alternating current (AC) terminal of the inverter 12. In such an example, the second busbars 204 may be part of the inverter 12. Additionally or alternatively, the first busbars 202 may be welded to winding terminals of the electric machine 14. As another example, there may be intermediate busbars interposed between the winding terminals and the first busbars 202. That is, the electric machine 14 may be electrically coupled to the first busbars 202 via the intermediate busbars, rather than directly. In such an example, the intermediate busbars may be mounted to the sealed block, as described above. Thus, the assemblies 200 may be oriented differently within electrical systems, such as a system comprising an electric machine and an inverter. Further, some of the assemblies 200 may be oriented differently than each other. For example, the inverter 12 may be electrically coupled to a combination of first busbars 202 and second busbars 204, and the electric machine 14 may be electrically coupled to the corresponding complementary busbars. Additionally, the assembly 200 may be used to electrically and mechanically couple different components than electric machines and inverters, in other examples with the same effect of reducing parts.

Turning to FIG. 7, a flowchart of a method 700 for connecting a first busbar to a second busbar without fasteners is shown. The method 700 may form a boltless busbar joint between the two busbars. For example, the method 700 may be executed to form the assembly 200 comprising the first busbar 202 and the second busbar 204 as shown in FIGS. 2-5.

The method 700 begins at 702, wherein contact areas of a first busbar and a second busbar are pre-treated with a surface texturing method. The first busbar and the second busbar may be conventional blank busbars prior to 702. A blank busbar may be a smooth, flat, rectangular prism shaped conductive material (e.g., metal). The busbars may be textured via a variety of surface texturing methods such as controlled abrasive polishing, electromechanical polishing with masking, laser surface texturing, micro-blasting, or a combination thereof. The texture may include a cross hatched pattern such as shown in FIG. 6, in at least some examples. In other examples the surface texture pattern may include other patterns that allow for slip in the sliding direction (e.g., direction shown by the arrow 314 of FIG. 3) so as not to degrade the pattern after repeated assembly and disassembly of the first busbar and the second busbar. For example, the surface texture pattern may comprise lines that are not parallel with lengths or widths of the first busbar and the second busbar. Contact areas may include surfaces of the first busbar and the second busbar positioned in face-sharing contact when assembled, such as in the assembly 200 of FIGS. 2-5. In some examples, additional surfaces to contact areas may also be texturized.

The method 700 proceeds to 704, wherein the second blank busbar is stamped to form two slots separating a middle piece from prongs. The two slots may be parallel. Further, the two slots may extend parallel with a length of the busbar along a distance shorter than the length. Thus, the slots may be formed lengthwise along the second busbar. The slots may not extend entirely across the length of the busbar such that the middle piece and the prongs are connected via a base integral with the middle piece and the prongs. The slots may be rectangular, ending in circular portions. However, the slots may include any shape of negative space cut out from the second busbar to separate the middle piece from the prongs. Stamping may include cutting (e.g., laser cutting, water cutting, EDM, etc.), punching, or otherwise forming such negative space with any suitable method. There may be two prongs positioned side by side widthwise with the middle piece therebetween and separated widthwise from the prongs by the slots. For examples, the middle piece may be interposed between the prongs with slots on either side of the middle piece. A width of the middle piece may be less than a width of the first busbar such that the first busbar may be in face-sharing contact with prongs on either side of the middle piece when positioned relative to the second busbar in subsequent steps of the method 700 (e.g., 708).

The method 700 proceeds to 706, wherein the middle piece is bent into a clip. Bending the middle piece into the clip may include plastically deforming the middle piece to form non-zero angles between surfaces of the clip and surfaces of the prongs. The bends may form widthwise edges, perpendicular to the lengthwise slots formed at 704. The middle piece may be bent in two or more places to form two or more segments. For example, the middle piece may be bent in three places such that the clip is S-shaped with three segments. In another example, the middle piece may be bent in two places such that the clip is L-shaped with two segments. Both L-shaped clips and S-shaped clips may include a first segment angled away from the prongs and a second segment angled with the first segment back towards the prongs. S-shaped clips may also include a third segment configured as a tab for easier manual pulling on the clip during assembly. Alternatively, the third segment may be configured to lie parallel with the prongs when assembled with the first busbar such that friction between the first busbar and the second busbar is increased, thereby increasing holding forces maintaining the joint between the two busbars. Other examples of clips may include further bends. The shape resulting from completing 706 may be a resting position of the second busbar which the second busbar may return to after elastic tension is released. Therefore, the second busbar may be formed form a material capable of both plastic and elastic behavior under different levels of stress.

The method 700 proceeds to 708, wherein the second blank busbar is interposed between the clip and the prongs. Interposing the first busbar between the clip and the prongs may include elastically deforming the second busbar by pulling the prongs and the clip away to broaden an opening therebetween. The clip may be manually elastically deformed from the resting position to receive the first busbar such that the clip applies a normal force when released (e.g., when pulling is discontinued), clamping the first busbar between the prongs and the clip. For example, discontinuing pulling may allow the clip to move back towards the resting state. The first busbar may be thicker than the resting distance between the clip and the prongs such that normal force between the clip and the prongs is applied to the first busbar on either side. In this way, the first busbar and the second busbar may be securely joined (e.g., mechanically and electrically coupled) via the clamping (e.g., compression) and friction without bolts. The textured surfaces of the first busbar and the second busbar may be positioned in face-sharing contact at the contact areas. The textures may increase fiction, thereby increasing securing forces holding the two busbars together. Thus, interposing the first busbar between the clip and the prongs may further include aligning the first busbar with the second busbar with parallel lengths and contact areas in face sharing contact.

The method 700 ends. An assembly, such as the assembly 200 of FIGS. 2-6, with a boltless joint between two busbars may result from completing the method 700. The assembly may be incorporated in a system where a busbar joint conventionally demands bolts or other fasteners. The assembly of the present disclosure may eliminate demand for such fasteners to attach the busbars together. For example, the clip may press the texturized surfaces together to securely join the two busbars. In this way, a removable mechanical and electrical connection may form between the two busbars such that the assembly may electrically and mechanically couple two components such as an electric machine and an inverter (e.g., electric machine 14 and inverter 12 of FIGS. 1 and 4-5).

The method 700 may be exemplary as to steps for connecting busbars in accordance with the present disclosure and other examples may adjust the order of such steps. For example, pre-treatment may occur before stamping as described above, or pre-treatment may occur between stamping and bending, or between bending and interposing in other examples.

Turning to FIGS. 8 and 9, a process 800 is shown in a series of front views 850 and side views 900, respectively, for forming the assembly 200 with a boltless joint between two busbars in accordance with the present disclosure. For example, the process 800 may visually show steps of the method 700 of FIG. 7.

A blank busbar 802 may be stamped into a stamped busbar 804. For example, step 704 of the method 700 may be executed to form the stamped busbar 804 from the blank busbar 802. The stamped busbar 804 may include two slots 312 separating a middle piece 808 from two prongs 214. The stamped busbar 804 may appear the same in the side views 900 as the blank busbar 802.

Following stamping, the middle piece 808 may be bent into the clip 216, forming a stamped and bent busbar 806. For example, step 706 of the method 700 may be executed to form the stamped and bent busbar 806 from the stamped busbar 804. Parts of the clip 216 may be spaced away in the x-direction from the prongs 214, as described above. The distance 248 between the clip 216 and the prongs 214 may be smaller than the thickness of a blank busbar. In at least some examples, the prongs 214 may remain flat (e.g., unbent). In this way, available contact surface area may be increased, thereby increasing friction between the two busbars in the assembly 200 and increasing mechanical and electrical coupling therebetween. In other examples, the prongs 214 may be bent into other shapes.

Surfaces of both busbars may be pre-treated by a surface texturing method. In FIGS. 8 and 9, texturing the surfaces is shown following bending. However, as described above, pre-treating contact areas of the busbars may occur at different points in the process 800, for example before stamping, between stamping and bending, or after bending. Textures of the texturized contact area surfaces may increase friction therebetween when positioned in face-sharing contact. In some examples, all surfaces of the busbars (e.g., including the contact areas) may be pre-treated such that all surfaces are evenly textured. Textured surfaces 278 of the first busbar 202 and textured surfaces 306 of the second busbar 204 may be textured by any suitable method for increasing roughness and other such surface properties related to friction, including controlled abrasive polishing, electromechanical polishing with masking, laser surface texturing, micro-blasting, or a combination thereof. The resulting surface texture patterns may resemble a cross-hatched pattern such as shown in FIG. 6. As described above, such a pattern may allow for vertical slip (e.g., in the y-direction) of surfaces with the pattern, allowing for assembly and disassembly of a boltless busbar joint of the present disclosure, such as in assembly 200, with reduced degradation of the pattern over time. In this way, durability of the mechanical and electrical connection of the boltless busbar joint may not be reduced by repeated assembly and disassembly, for example for maintenance of the system including the boltless busbar joint.

Finally, the first busbar 202 may be inserted into the space between the clip 216 and the prongs 214 by widening the distance 248 and interposing the first busbar between the clip 216 and the prongs 214. For example, the distance 248 may be manually widened by an installer by pulling the third segment 236 away from the prongs 214 (e.g., in a positive x-direction). The installer may slide the first busbar 202 and the second busbar 204 into alignment with the first busbar 202 overlapping the prongs 214 and the clip 216 from the front views 850. The second busbar 204 may resist the widening of the distance 248. For example, the second busbar 204 may be elastically deformed in the assembly 200 from the resting position of the second busbar 204. Thus, the clip 216 may press onto the first busbar 202 when released from tension, compressing the first busbar 202 between the prongs 214 and the clip 216.

In this way, two busbars, such as the first busbar 202 and the second busbar 204, may be electrically and mechanically coupled without other components such as fasteners. Therefore, bolts, nuts, and seals demanded for conventional busbar joints may not be included in a busbar joint of the present disclosure. Instead, one of the busbars may be modified to form an integral clip which clamps the other busbar compressively to form a mechanical and electrical connection therebetween. Further, surfaces of the two busbars may be textured to increase friction therebetween, increasing stability and durability of the mechanical and electrical connection.

The technical effect of the boltless busbar joint of the present disclosure is to electrically and mechanically couple two busbars without demand for additional parts such as bolts and nuts or other non-integral fasteners. The boltless busbar of the present disclosure may have increased stability and durability of the mechanical and electrical connection compared to conventional busbar joints, for example couplings between busbars with bolts. Additionally, surface textures of the busbars may decrease formation of hotspots, at least partially mitigating excessive thermal accumulation of such conventional busbar joints. Moreover, due to increased stability of the boltless busbar joint of the present disclosure, an HVIL and cover may not be demanded. By reducing parts demanded to mechanically and electrically couple the busbars, resource demand, complexity of manufacturing, and volume demand may be decreased.

The disclosure also provides support for a method for connecting a first busbar to a second busbar without fasteners, comprising: stamping the second busbar to form two slots separating a middle piece from prongs, bending the middle piece into a clip, and interposing the first busbar between the clip and the prongs, where contact areas of the first and second busbars are pre-treated with a surface texturing method. In a first example of the method, stamping includes cutting, punching, or otherwise forming negative space between the middle piece and each of the prongs. In a second example of the method, optionally including the first example, bending includes plastically deforming the middle piece to include two or more segments at non-zero angles with one another. In a third example of the method, optionally including one or both of the first and second examples, interposing the first busbar between the clip and the prongs includes elastically deforming the second busbar by pulling the prongs and the clip away to broaden an opening therebetween. In a fourth example of the method, optionally including one or more or each of the first through third examples, interposing the first busbar between the clip and the prongs further includes aligning the first busbar with the second busbar with parallel lengths and contact areas in face-sharing contact. In a fifth example of the method, optionally including one or more or each of the first through fourth examples, interposing the first busbar between the clip and the prongs further includes clamping the first busbar between the clip and the prongs by discontinuing the pulling. In a sixth example of the method, optionally including one or more or each of the first through fifth examples, the first busbar and the second busbar are mechanically and electrically coupled via the clamping and friction between the contact areas. In a seventh example of the method, optionally including one or more or each of the first through sixth examples, the contact areas include a prong contact surface of the first busbar and prong inner surfaces of the prongs. In an eighth example of the method, optionally including one or more or each of the first through seventh examples, the surface texturing method is controlled abrasive polishing, electromechanical polishing with masking, laser surface texturing, micro-blasting, or a combination thereof.

The disclosure also provides support for an assembly, comprising: a first busbar with a prong contact surface and a clip contact surface, the prong contact surface and the clip contact surface facing opposite directions, and a second busbar having prongs integral with a clip, the clip comprising segments including a first segment bent at a first non-zero angle with the prongs and a second segment bent at a second non-zero angle with the first segment, wherein the first busbar is interposed and compressed between the prongs and the clip with the prong contact surface in face-sharing contact with prong inner surfaces of the prongs and the clip contact surface in face-sharing contact with clip inner surfaces of the clip such that the first busbar and the second busbar are removably, electrically, and mechanically coupled without fasteners. In a first example of the system, contact areas, including the prong contact surface and prong inner surfaces, are pre-treated with a surface texturing method to produce a surface texture pattern that is cross-hatched with lines that are not parallel with lengths or widths of the first busbar and the second busbar. In a second example of the system, optionally including the first example, the second busbar is elastically deformed in the assembly such that the first angle and/or the second angle are greater compared to a resting position of the second busbar. In a third example of the system, optionally including one or both of the first and second examples, the segments further include a third segment bent at a third non-zero angle with the second segment. In a fourth example of the system, optionally including one or more or each of the first through third examples, the first segment and the third segment are bent in opposite directions from the second segment such that the clip is S-shaped. In a fifth example of the system, optionally including one or more or each of the first through fourth examples, the first busbar is flat.

The disclosure also provides support for an assembly, comprising: a first busbar, and a second busbar including a clip that is bent and two prongs positioned on either side of the clip, wherein the first busbar is wider than the clip such that the first busbar is in face-sharing contact with both of the prongs and the clip, and wherein the clip is under elastic tension that clamps the first busbar between the prongs and the clip, mechanically and electrically coupling the first busbar with the second busbar. In a first example of the system, contact areas where the first busbar is in face-sharing contact with the prongs and the clip are textured with a surface texture pattern that allows for slip in a direction parallel with the prongs. In a second example of the system, optionally including the first example, the clip is separated from the prongs by slots extending partially along a length of the second busbar and ending in circular portions. In a third example of the system, optionally including one or both of the first and second examples, bends of the clip are perpendicular to the slots. In a fourth example of the system, optionally including one or more or each of the first through third examples, the first busbar and the second busbar are separable by releasing the elastic tension.

FIGS. 1-6 and 8-9 show example configurations with relative positioning of the various components. FIGS. 2-3 and 8-9 are shown approximately to scale, although other relative dimensions may be used. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

Unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for connecting a first busbar to a second busbar without fasteners, comprising:
stamping the second busbar to form two slots separating a middle piece from prongs;
bending the middle piece into a clip; and
interposing the first busbar between the clip and the prongs, where contact areas of the first and second busbars are pre-treated with a surface texturing method.

2. The method of claim 1, wherein stamping includes cutting, punching, or otherwise forming negative space between the middle piece and each of the prongs.

3. The method of claim 1, wherein bending includes plastically deforming the middle piece to include two or more segments at non-zero angles with one another.

4. The method of claim 1, wherein interposing the first busbar between the clip and the prongs includes elastically deforming the second busbar by pulling the prongs and the clip away to broaden an opening therebetween.

5. The method of claim 4, wherein interposing the first busbar between the clip and the prongs further includes aligning the first busbar with the second busbar with parallel lengths and contact areas in face-sharing contact.

6. The method of claim 5, wherein interposing the first busbar between the clip and the prongs further includes clamping the first busbar between the clip and the prongs by discontinuing the pulling.

7. The method of claim 6, wherein the first busbar and the second busbar are mechanically and electrically coupled via the clamping and friction between the contact areas.

8. The method of claim 1, wherein the contact areas include a prong contact surface of the first busbar and inner surfaces of the prongs which face the clip.

9. The method of claim 1, wherein the surface texturing method is controlled abrasive polishing, electromechanical polishing with masking, laser surface texturing, micro-blasting, or a combination thereof.

10. An assembly, comprising:
a first busbar with a prong contact surface and a clip contact surface, the prong contact surface and the clip contact surface facing opposite directions; and
a second busbar having prongs integral with a clip, the clip comprising segments including a first segment bent at a first non-zero angle with the prongs and a second segment bent at a second non-zero angle with the first segment, wherein the first busbar is interposed and compressed between the prongs and the clip with the prong contact surface in face-sharing contact with prong inner surfaces of the prongs and the clip contact surface in face-sharing contact with clip inner surfaces of the clip such that the first busbar and the second busbar are removably, electrically, and mechanically coupled without fasteners.

11. The assembly of claim 10, wherein contact areas, including the prong contact surface and prong inner surfaces, are pre-treated with a surface texturing method to produce a surface texture pattern.

12. The assembly of claim 10, wherein the second busbar is elastically deformed in the assembly such that the first angle and/or the second angle are greater compared to a resting position of the second busbar.

13. The assembly of claim 10, wherein the segments further include a third segment bent at a third non-zero angle with the second segment.

14. The assembly of claim 13, wherein the first segment and the third segment are bent in opposite directions from the second segment such that the clip is S-shaped.

15. The assembly of claim 10, wherein the first busbar is flat.

16. A vehicle, comprising:
an energy storage device;
an inverter configured to condition electrical energy in and out of the energy storage device; and
an electric machine configured to convert the electrical energy to mechanical energy that is delivered to drive wheels, wherein the electric machine is electrically and mechanically coupled to the inverter via a boltless busbar joint, including:
a first busbar; and
a second busbar including a clip that is bent and two prongs positioned on either side of the clip, wherein the first busbar is wider than the clip such that the first busbar is in face-sharing contact with both of the prongs and the clip, and wherein the clip is under elastic tension that clamps the first busbar between the prongs and the clip, mechanically and electrically coupling the first busbar with the second busbar.

17. The vehicle of claim 16, wherein contact areas where the first busbar is in face-sharing contact with the prongs and the clip are textured with a surface texture pattern that allows for slip in a direction parallel with the prongs.

18. The vehicle of claim 16, wherein the clip is separated from the prongs by slots extending partially along a length of the second busbar and ending in circular portions.

19. The vehicle of claim 18, wherein bends of the clip are perpendicular to the slots.

20. The vehicle of claim 16, wherein the first busbar and the second busbar are separable by releasing the elastic tension such that the boltless busbar joint is configured to couple and decouple the inverter with the electric machine without bolts.
